(19) United States
(12) Patent Application Publication
(10) Pub. No.: US 2024/0195077 A1
(43) Pub. Date: Jun. 13, 2024

(54) ALL-INTEGRATED PHOTONIC TRANSCEIVER WITH A COMMON APERTURE

(71) Applicant: California Institute of Technology, Pasadena, CA (US)

(72) Inventors: Aroutin Khachaturian, Tujunga, CA (US); Babak Bahari, Irvine, CA (US); Seyed Ali Hajimiri, La Canada, CA (US)

(73) Assignee: California Institute of Technology, Pasadena, CA (US)

(21) Appl. No.: 18/537,495

(22) Filed: Dec. 12, 2023

Related U.S. Application Data
(60) Provisional application No. 63/432,007, filed on Dec. 12, 2022.

(51) Int. Cl. H01Q 15/02; H01Q 3/26

(52) U.S. Cl. CPC H01Q 15/02; H01Q 3/26

(57) ABSTRACT

An integrated photonic platform for a transceiver aperture. New functions that can only be realized in the integrated platform are further described.

### CROSS REFERENCE TO RELATED APPLICATIONS

This application claims the benefit under 35 U.S.C. Section 119(e) of U.S. Provisional Application No. 63/432,007, filed Dec. 12, 2022, by Aroutin Khachaturian, Babak Bahari Ali Hajimiri, entitled “AN ALL-INTEGRATED PHOTONIC TRANSCEIVER WITH A COMMON APERTURE,” CIT-8932-P, which application is incorporated by reference herein. This application is related to:

PCT application Serial No. PCT/US23/74682 by Aroutin Khachaturian et. al. filed on Sep. 20, 2023, entitled ALL INTEGRATED COMPLEX SIGNAL GENERATION AND PROCESSING, which application claims the benefit under 35 U.S.C. Section 119(e) of U.S. Provisional Application No. 63/408,403, filed Sep. 20, 2022, by Aroutin Khachaturian, David Baum, and Seyed Ali Hajimiri, entitled “ALL INTEGRATED COMPLEX SIGNAL GENERATION AND PROCESSING,”

PCT application Serial No. PCT/US23/71422 on Aug. 1, 2023 by Aroutin Khachaturian et. al, entitled “COMPLEX-WAVEFRONT PHOTONIC TRANSCEIVER PROCESSOR” which application claims the benefit under 35 U.S.C. Section 119(e) of U.S. Provisional Application Ser. No. 63/394,228, filed on Aug. 1, 2022, by Aroutin Khachaturian, Parham Porsandeh Khial and Seyed Ali Hajimiri, entitled “COMPLEX-WAVEFRONT PHOTONIC TRANSCEIVER PROCESSOR,” docket number CIT 8858-P; and U.S. patent application Ser. No. 17/726,867 filed on Apr. 22, 2022, by Aroutin Khachaturian et. al, entitled “COHERENT PHOTONICS IMAGER WITH OPTICAL CARRIER SUPPRESSION AND PHASE DETECTION CAPABILITY” which application claims the benefit under 35 USC 119(e) of U.S. Provisional Patent Application Ser. No. 63/178,118, filed Apr. 22, 2021, by Aroutin Khachaturian, Behrooz Abiri, Seyed Mohammadreza Fatemi, and Seyed Ali Hajimiri, entitled “COHERENT PHOTONICS IMAGER WITH OPTICAL CARRIER SUPPRESSION AND PHASE DETECTION CAPABILITY,” (CIT-8637-P),
all of which applications are incorporated by reference herein.

### BACKGROUND OF THE INVENTION

### 1. Field of the Invention

The present disclosure relates to transceiver apertures and methods of making the same.

### 2. Description of the Related Art

Photonic transceiver architectures typically rely on two independent apertures, one for the transmitter and one for the receiver (FIG. 1(a)) with separate beamforming mechanisms via physical lenses or chip-based wavefront generation such as optical phased arrays. These systems require complex packaging of the transmitter and receiver sub-blocks which impacts the cost, complexity, and performance parameters of the photonic transceiver.

Alternatively, one can use a common aperture transceiver architecture such as the one shown in FIG. 1(b). In this approach, linearly polarized light (p) is emitted from the transmitter and passes through the polarization beam splitter (PBS). The linearly polarized light reaches the quarter-wave plate (QWP) with the fast axis at +45° angle [4]. The resulting light at the output is left-handed circularly polarized (LHCP). The left-handed polarized light is emitted through the common aperture. In the case where the aperture is set up to transmit light and receive reflected signal (reflective transceiver operations), the returned light is right-handed circularly polarized (RHCP) upon returning to the common aperture, and upon contact with the QWP becomes (s) polarization. The s-polarized light is reflected from the polarization beam splitter and is collected by the receiver aperture. This conventional common aperture transceiver requires many discrete components (polarization beam splitter, quarter wave plate, and lens). The discrete components need to be positioned at precise locations with respect to each other which adds to the complexity, cost, and reliability of conventional transceivers. What is needed is an integrated platform. The present disclosure satisfies this need.

### SUMMARY OF THE INVENTION

An integrated photonic architecture for photonic wavefront transmission and reception using a common aperture. Embodiments of this architecture enhance the performance of optical transceivers by utilizing the reliability and repeatability of integrated photonics platforms. This integration enables enhanced beam processing capabilities at a reduced size, cost, and complexity. This architecture can enhance coherent transceiver performance for many applications, including remote sensing, LiDAR, high-speed data communication, medical imaging, and high-performance computing.

### BRIEF DESCRIPTION OF THE DRAWINGS

Referring now to the drawings in which like reference numbers represent corresponding parts throughout:

FIG. 1a. Independent Tx/Rx aperture transceiver.

FIG. 1b. Common aperture transceiver.

FIG. 2a. Generic transceiver with a common aperture according to an embodiment of the present invention. FIG. 2b. Exemplary common aperture transceiver using directional couplers and grating couplers.

FIG. 3a Generic dual polarization radiator according to an embodiment of the present invention. FIG. 3b. Exemplary multi-polarization radiator for integrated silicon photonics process using a square grid of radiators.

FIG. 4a. A multi-port transceiver antenna. TE mode of the waveguide is coupled to free-space and transmitted as p polarized. The returned s-polarized light is collected in the Rx port of the 2D grating. FIG. 4b. Exemplary multi-polarization photonic transceiver using a multi-port transceiver antenna.

FIGS. 5a and 5b: Multi-polarization transceiver antenna. FIG. 5a: 5-port transceiver antenna. The ratio of the power (controlled by a programmable splitter) and the relative phase of the transmitter ports (in this example, port 1 and port 3) can be adjusted to achieve linear (s,p), circular (RH, LH), or elliptical polarization in the transmit beam. The receiver ports (shown as port 2 and port 4 here) can be adjusted to receive any polarization of light. The phase shifter and tunable splitter can correctly combine the power collected in the Rx ports. FIG. 5b. For the generation and capture of circular polarization, a 3-port co-spiral radiator can be used.

FIG. 6: Optical phased array transceiver implemented using multi-port transceiver antennas. The coherent signal is split into N paths, and the relative path of the N path is adjusted using integrated phase shifters. The adjustable polarization radiators are configured to radiate any desired polarization. The adjustable polarization radiators receive any desired polarization and coherently beamform using integrated phase shifters and combiners.

FIG. 7. Flowchart illustrating a method of making a transceiver.

FIG. 8. Flowchart illustrating a method of using the transceiver.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### First Embodiment: Common Transceiver Aperture

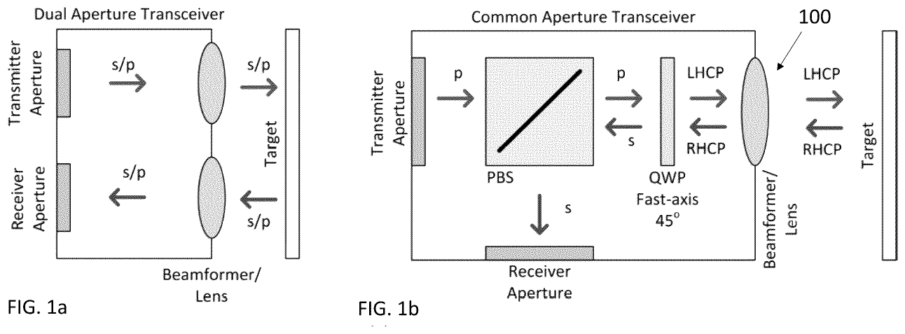

In the conventional transceiver, as shown in FIG. 1, the transmitter pixel is typically comprised of a photonic radiator. The receiver pixel can operate based on direct detection by directly collecting light using a photodiode. Alternatively, the receiver pixel can operate based on heterodyne or homodyne mixing. In this scenario, the received light is collected using a photonic radiator (polarization sensitive or insensitive) and mixed with a local oscillator (LO) in a balanced or unbalanced mixer. It is possible to mix the receive and LO in an IQ mixer to suppress the effects and non-idealities of the optical carrier signal.

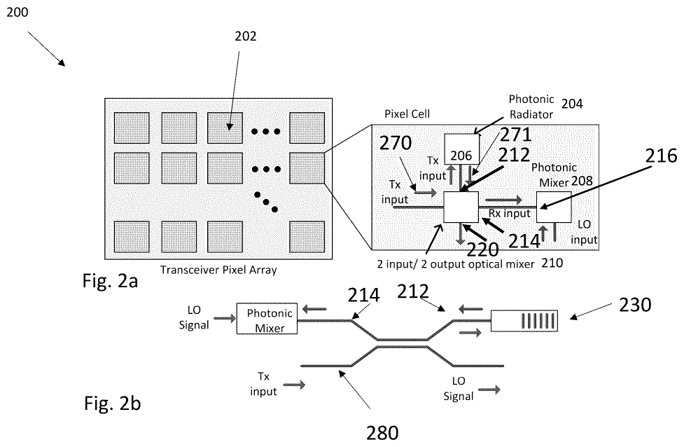

FIG. 2a illustrates a common transceiver aperture comprising a transceiver unit cell with Tx and Rx components integrated into a unit cell with a shared photonic radiator (from which electromagnetic radiation is transmitted or received). More specifically, FIG. 2a illustrates a transceiver aperture 200, comprising an array of pixels 202, each of the pixels comprising a photonic radiator 204 comprising one or more ports 206; a photonic mixer 208 comprising an Rx input and a local oscillator (LO) input; and an optical mixer 210 comprising a Tx input; an input/output port 212; a first output 214; and a second output 220. The input/output port 212 is coupled to the one or more ports 206 of the photonic radiator 204 and the first output 214 is coupled to the Rx input 216. The Tx input receives Tx signals 270 that are transmitted via the input/output port to the radiator 204 and that are used to generate transmission of electromagnetic radiation from the radiator. The input/output port further receives Rx signals 271 generated in response to the electromagnetic radiation received on the radiator and that are forwarded to the photonic mixer for processing.

This architecture does not require polarization beam splitters or quarter-wave plates for operations. In the absence of non-reciprocal elements and asymmetries, the system incurs an additional 6 dB of loss. If the forward transmission's 3 dB lost signal is recycled for the local oscillator, then the system incurs 3 dB of loss.

In one exemplary implementation, the two input and two output mixer is realized using a multi mode interferometer (MMIs). FIG. 2 illustrates one exemplary implementation wherein the structure is realized using directional couplers. FIG. 2b illustrates the radiator can be realized using grating couplers 230.

### Second Embodiment: Integration of the Polarization Beam Splitter

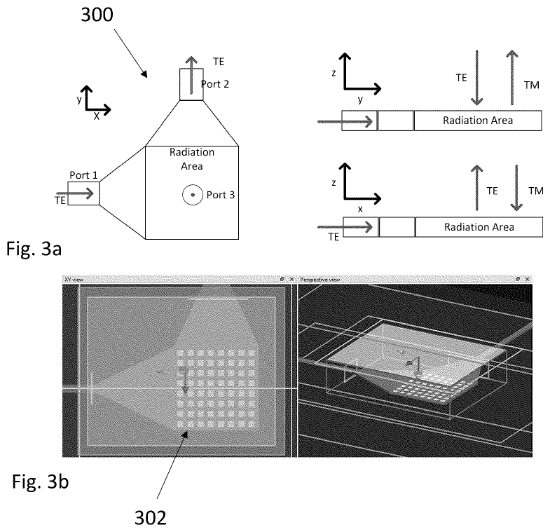

In the design of FIG. 1, the transmitter emits a linearly polarized light which is typically achieved using a polarization filter or integrated linearly polarized radiators. These radiators have two ports. It is possible to create dual polarization radiators that couple/radiate s and p polarization of the light into different ports of the radiator. FIG. 3a illustrates an example of a multi-port radiator (MPR) 300. FIG. 3b illustrates an exemplary implementation realized using an array of square gratings 302. Furthermore, any undesired back-reflected transmitted signal can be filtered out in analog or digital post-processing.

### Third Embodiment: Dual Polarization Transceiver by Multi-Port Transceiver Beam Splitting

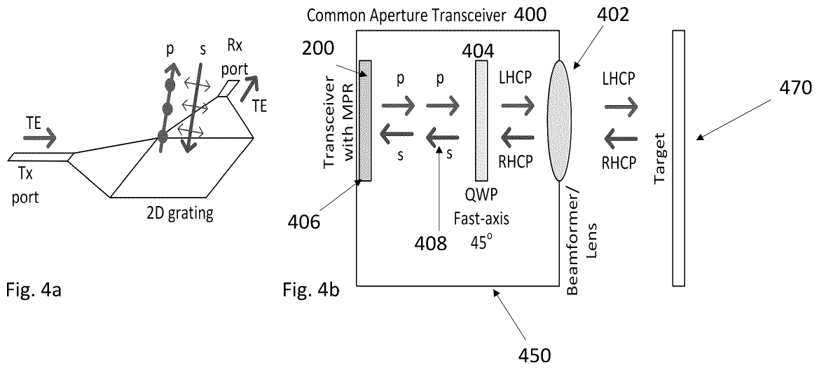

FIG. 4 illustrates the advantage of the dual polarization radiator for photonic transceiver application (compared to the architecture shown in FIG. 1) of enabling the co-integration of the polarization beam splitter and the radiator. This reduces photonic transceiver complexity. Furthermore, it improves signal isolation between the transmitter and the receiver. In addition, unlike the conventional structure in FIG. 1 where the transmitter and receiver signal must be preset to be s or p, in the integrated variant, any combination of s and p polarization can be used.

FIG. 4 illustrates am an embodiment of the transceiver 400 comprising the aperture 200, further comprising a beamformer 402; and a quarter wave plate 404 (or polarization beam splitter) optically coupled between the photonic radiator and the beamformer, wherein the electromagnetic radiation 408 transmitted from or received on the photonic radiator 406 is transmitted through the quarter wave plate (or the beamsplitter) to/from the beamformer 402.

In one embodiment, the dual polarization radiator radiates p polarization and receives s polarization. In another embodiment, it does the reverse. Furthermore, the transceiver can radiate both s and p polarizations and generate circular polarization. In another embodiment, the dual polarization transceiver in FIG. 4 is implemented as both the transmitter and the receiver apertures in FIG. 1(b) where the first dual polarization transceiver radiates in one polarization, and the second dual polarization transceiver radiates in the perpendicular polarization. The combined system can radiate both s and p polarizations and receiver collects and processes both s and p polarizations. The modified architecture can be used for polarimetry, polarization diverse transceiver, or to double the data transmission bandwidth in point-to-point communication systems.

### Fourth Embodiment: Integration of the Quarter Wave Plate

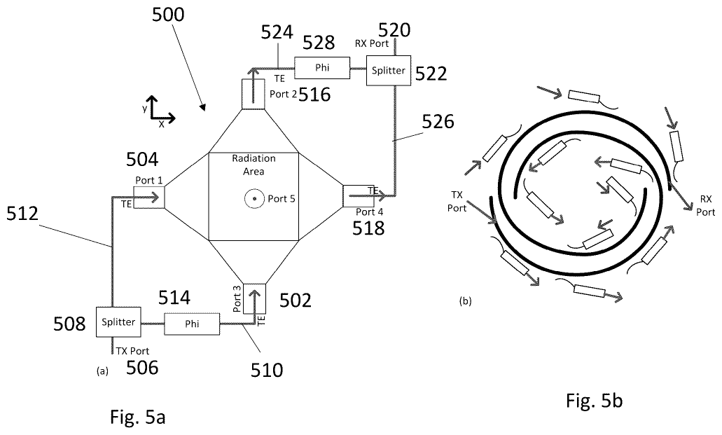

As discussed above, it is possible to radiate circular polarization of desired handedness from the chip, thereby achieving the function of a quarter-wave plate on an integrated chip. FIG. 5 illustrates two methods of converting linear polarization to circular polarization. FIG. 5 illustrates an embodiment wherein the pixels 202 further comprise MDR 500, and:
the Tx ports comprising a first Tx port 502; a second Tx port 504; and a third Tx port 506, the third Tx port connected to the photonic radiator via the first Tx port and the second Tx port;
a first splitter 508 connecting the third Tx port to a first Tx waveguide 510 and a second Tx waveguide 512,
a first phase shifter 514, the first Tx waveguide connecting the first phase shifter between the first splitter and the first Tx port;
the Rx ports comprising a first Rx port 516; a second Rx port 518; and a third Rx 520 port, the third Rx port connected to the photonic radiator via the first Rx port and the second Rx port;
a second splitter 522 connecting the third Rx port to a first Rx waveguide 524 and a second Rx waveguide 526; and
a second phase shifter 528, the first Rx waveguide connecting the second phase shifter between first Rx port and the second splitter.

### Fifth Embodiment: Integration of the Common Lens

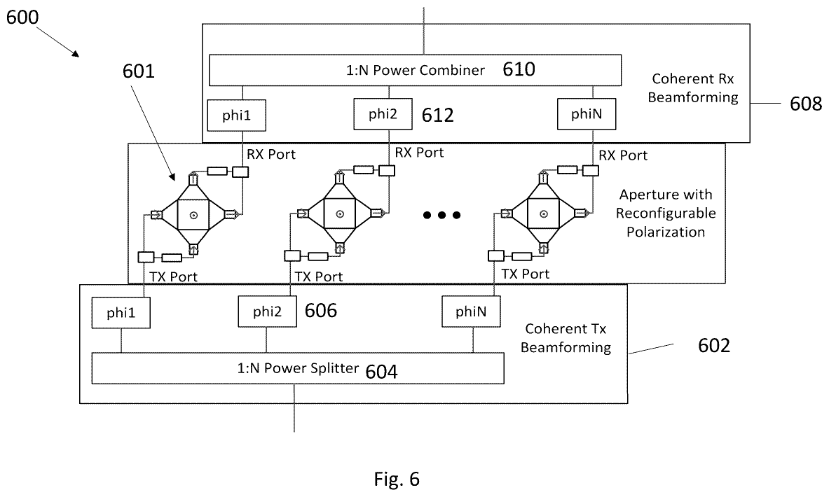

The architecture can be extended to coherent beamforming applications and be applied in integrated optical phased array applications as described in [1-3]. An optical phased array transmitter operates by adjusting the relative phase of the transmitter elements. An optical phased array receiver operates by adjusting the relative phase of the received signal or the coherent downconverting LO signal. FIG. 6 illustrates an integrated transceiver phased array 600 with a common aperture using the multi-polarization radiators 601, 300 described herein. This enables the integration of the beamformer (lens) 100 in FIG. 1 on-chip, which reduces system cost and complexity. In one exemplary implementation, the quarter-wave plate can be integrated on-chip 450. In another embodiment, the quarter-wave plate is off-chip.

FIG. 6 illustrates an embodiment of a transceiver aperture further comprising a Tx beamformer 602; comprising a 1:N power splitter 604 having an input and N outputs, wherein N is an integer representing a number of the pixels and each of the N outputs is connected to a different one of the photonic radiators in a different one of the pixels; and a first plurality of N phase shifters 606, wherein the i^{th} one of the phase shifters couples the i^{th} one of the N outputs to the i^{th} one of the pixels, for 1≤i≤N.

The transceiver aperture further comprises an Rx beamformer, comprising a 1:N power combiner 610 having N inputs and one output, wherein each of the N inputs is connected to a different one of the photonic radiators in a different one of the pixels; and a second plurality of N phase shifters 612, wherein the i^{th} one of the phase shifters couples the i^{th} one of the N inputs to the i^{th} one of the pixels, for 1≤i≤N.

### Sixth Embodiment: Process Steps

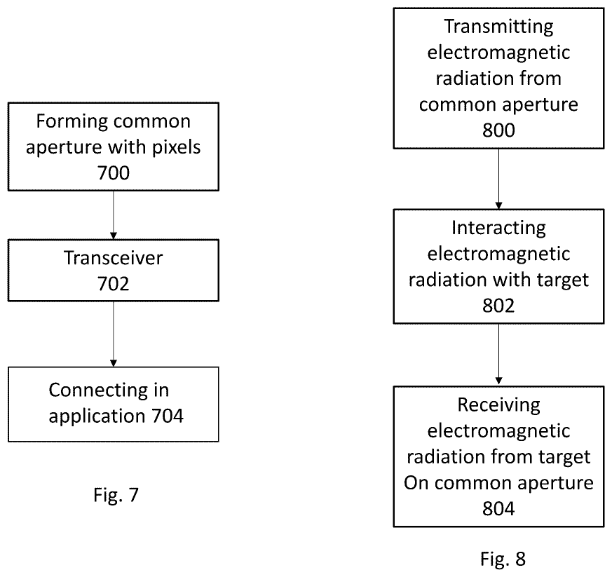

FIG. 7 illustrates a method of making a transceiver aperture generally comprises lithographically (e.g., photolithographically) forming 700 an array of pixels on a silicon on insulator substrate, each of the pixels comprising a photonic integrated circuit comprising a photonic radiator comprising one or more ports; a photonic mixer comprising an Rx input and a local oscillator (LO) input; and an optical mixer comprising a Tx input; an input/output port; a first output; and a second output. The input/output port is coupled to the one or more ports of the photonic radiator and the first output is coupled to the Rx input. Block 702 represents optionally connecting the aperture in a transceiver. In one or more embodiments, the transceiver is implemented in a variety of standard silicon photonic, indium phosphide photonic, or any other nanophotonic platform that offers on-chip photonic waveguides. Block 704 represents optionally connecting the transceiver in an application, e.g., a LiDAR, a high-speed data communication system, a medical imaging system, a high-performance computing system, or a remote sensing system comprising the (e.g., complex wavefront) transceiver.

The photonic radiator can comprise a capture area (e.g., radiation area) comprising a grating comprising an array of metal stripes deposited on the silicon. The optical mixer can comprise a MMI comprising silicon waveguides clad by silicon dioxide underneath, on top, and on sides of the waveguide. The photonic mixer can comprise a silicon photodiode patterned on the silicon on insulator substate connected to two silicon waveguides (clad by silicon dioxide), wherein one silicon waveguide is for the Rx input and the other for the LO input. The power splitters and power combiners comprise directional couplers, e.g., comprising silicon waveguides clad by silicon dioxide and coupled by a silicon dioxide gap in the coupling region before the waveguides separate (splitter) or combine (combiner).

As known in the art, the phase shifter may comprise a modulator comprising a material (e.g., liquid crystal or nonlinear material, or electro-optic material, or thermo-optic material) thermally or electrically coupled to an electrode, wherein application of a voltage to the electrode (via bias lines) controls, e.g., resistive heating, piezoelectric actuation, bi refringence, or electro-optic actuation of the material so as to control a phase of the electromagnetic field passing through the material. Such modulators can be coupled to waveguides carrying the electromagnetic field, e.g., in an interferometer, to further modulate the phase.

A computer (e.g., one or more integrated circuit, application specific integrated circuit (ASIC), field programmable gate array (FPGA)) can be coupled to or included in the phase shifters, modulator, splitters, or combiners) to program the power and/or phase of the Rx signals and Tx signals.

Although the figures illustrate waveguides (e.g., silicon waveguides clad by silicon dioxide) connecting various components in the pixels, these waveguides can be more generally paths for transmitting the Tx signals and Rx signals comprising electromagnetic radiation, waves, or fields (e.g., having any wavelength including, but not limited to, wavelengths in a range from visible to infrared) used to generate (or that are received in response to) the electromagnetic radiation transmitted from (or received on) the radiator. The electromagnetic radiation/waves/fields can be modulated with signals (e.g., waveforms) at various frequencies including, but not limited to, radio frequencies.

Illustrative embodiments of the present invention include, but are not limited to, the following (referring also to FIGS. 1-6).

1. A transceiver aperture 200, comprising:
an array of pixels 202, each of the pixels comprising:
a photonic radiator 204 comprising one or more ports 206;
a photonic mixer 208 comprising an Rx input and a local oscillator (LO) input; and
an optical mixer 210 comprising a Tx input; an input/output port 212; a first output 214;
   and a second output 220, wherein the input/output port is coupled to the one or more ports of the photonic radiator and the first output is coupled to the Rx input.

2. The transceiver aperture of embodiment 1, wherein the optical mixer 210 comprises a multi-mode interferometer (MMI).

3. The transceiver of embodiment 1 or 2, wherein the photonic radiator comprises a directional coupler, a grating coupler, or a multi port radiator (MDR) 300 comprising multiple ports for input/output of different polarizations of electromagnetic radiation received on or transmitted to the MDR.

4. The transceiver aperture of any of the embodiments 1-3, wherein the photonic radiator comprises a multiport radiator comprising an array of square gratings 302.

5 The transceiver aperture of any of the embodiments 1-4, wherein:
the photonic radiator comprises a multiport radiator (MPR) comprising the ports comprising:
   one or more Tx ports for input of a Tx signal for generating a first polarization of electromagnetic radiation transmitted from the photonic radiator; and
   one or more Rx ports for output of an Rx signal in response to a second polarization of the electromagnetic radiation received on the photonic radiator;
the Tx ports and the Rx ports are each coupled to the input/output port of the optical mixer; and
the optical mixer routes the Tx ports to the Tx input and the Rx ports to the Rx input via the first output.

6. The transceiver aperture of embodiment 5, wherein:
the first polarization is different from the second polarization; and
the first polarization and the second polarization each independently comprise a linear polarization, a circular polarization, or elliptical polarization.

7. A transceiver 400 comprising the aperture of embodiment 5 or 6, further comprising:
a beamformer 402; and
a quarter wave plate 404 (or polarization beam splitter) optically coupled between the photonic radiator and the beamformer, wherein the electromagnetic radiation 408 transmitted from or received on the photonic radiator 406 is transmitted through the quarter wave plate (or the beamsplitter) to/from the beamformer.

8. The transceiver aperture of embodiment 5, 6, or 7 wherein each of the pixels further comprises:
the Tx ports comprising a first Tx port 502; a second Tx port 504; and a third Tx port 506, the third Tx port connected to the photonic radiator via the first Tx port and the second Tx port;
a first splitter 508 connecting the third Tx port to a first Tx waveguide 510 and a second Tx waveguide 512,
a first phase shifter 514, the first Tx waveguide connecting the first phase shifter between the first splitter and the first Tx port;
the Rx ports comprising a first Rx port 516; a second Rx port 518; and a third Rx 520 port, the third Rx port connected to the photonic radiator via the first Rx port and the second Rx port;
a second splitter 522 connecting the third Rx port to a first Rx waveguide 524 and a second Rx waveguide 526; and
a second phase shifter 528, the first Rx waveguide connecting the second phase shifter between first Rx port and the second splitter.

9. The transceiver aperture of embodiment 5, 6, 7, or 8 wherein each of the pixels comprise:
the Tx ports comprising a plurality of Tx ports 502, 504; a Tx splitter 508 configured to control a power of the Tx signal inputted to each of the Tx ports; and a Tx phase shifter 514 coupled to control a relative phase of the Tx signal inputted to each of the ports so as to adjust a transmit polarization of the electromagnetic radiation transmitted from the photonic radiator in response to the Tx signals; and
the Rx ports comprising a plurality of Rx ports 516, 518; an Rx splitter 522 configured to control and combine a power of the Rx signals outputted from each of the Rx ports in response to electromagnetic radiation received on the photonic radiator; and an Rx phase shifter 528 coupled to control a relative phase of the Rx signals outputted from each of the ports, so as to correctly receive a polarization of the electromagnetic radiation.

10. The transceiver aperture of any of the embodiments 5-9, further comprising:
a Tx beamformer 602; comprising:
a 1:N power splitter 604 having an input and N outputs, wherein N is a number of the pixels and each of the N outputs is connected to a different one of the photonic radiators in a different one of the pixels; and
a first plurality of N phase shifters 606, wherein the i^{th} one of the phase shifters couples the i^{th} one of the N outputs to the i^{th} one of the pixels, for 1≤i≤N; and
an Rx beamformer, comprising:
   a 1:N power combiner 610 having N inputs and one output, wherein each of the N inputs is connected to a different one of the photonic radiators in a different one of the pixels; and
   a second plurality of N phase shifters 612, wherein the i^{th} one of the phase shifters couples the i^{th} one of the N inputs to the i^{th} one of the pixels, for 1≤i≤N.

11. A phased array transceiver comprising the aperture of embodiment 10.

12. The transceiver aperture of any of the embodiments 8-10, further comprising a computer coupled to the power splitter, the phase shifters, and the power combiner, wherein the computer is configured to:
control the phase shifters to control a relative phase of the Tx signals inputted to each of the Tx ports or the Rx signals received from each of the Rx ports; and
control the splitter to control the power of the Tx signals transmitted to each of the Tx ports; and
control the combiner to control a power of the Rx signals outputted from each or the Rx ports.

13. The transceiver aperture of embodiment 12, wherein the relative phase and power are
controlled to convert linear polarization to circular or elliptical polarization.

14. The transceiver aperture of any of the embodiments 1-13, wherein the photonic mixer comprises a detector positioned to detect and mix the Rx signal received at the Rx input and a LO signal received at the LO input, and output a detection signal in response thereto, the detection signal comprising a difference frequency between a frequency of the LO signal and a frequency of the Rx signal.

15. The transceiver aperture of embodiment 14, wherein the photonic mixer comprises an In phase-Quadrature (IQ) mixer.

16. A complex wavefront transceiver 400 comprising the aperture of any of the embodiments 1-15, wherein the photonic radiator transmits and receives an arbitrary complex wavefront through the aperture, wherein the wavefront comprises any arbitrary superposition of sine waves having different phases and/or amplitudes.

17. A LIDAR, a high-speed data communication system, a medical imaging system, a high-performance computing system, or a remote sensing system comprising the complex wavefront transceiver of embodiment 15 or the aperture of any of the embodiments 1-16, or wherein the aperture of any of the embodiments 1-16 is configured for a LiDAR, a high-speed data communication system, a medical imaging system, a high-performance computing system, or a remote sensing system comprising the complex wavefront transceiver.

18. A method of making a transceiver aperture, comprising:
lithographically forming an array of pixels on a silicon on insulator substrate, each of the pixels comprising a photonic integrated circuit comprising:
a photonic radiator comprising one or more ports;
a photonic mixer comprising an Rx input and a local oscillator (LO) input; and
an optical mixer comprising a Tx input; an input/output port; a first output; and a second output, wherein the input/output port is coupled to the one or more ports of the photonic radiator and the first output is coupled to the Rx input.

19. The method of embodiment 17, further comprising forming waveguides connecting the photonic radiator, the photonic mixer; and the optical mixer.

20. FIG. 7 illustrates a method of making a transceiver aperture, comprising:
lithographically forming 700 an array of pixels on a silicon on insulator substrate, each of the pixels comprising a photonic integrated circuit comprising:
a photonic radiator comprising one or more ports;
a photonic mixer comprising an Rx input and a local oscillator (LO) input; and

21. FIG. 8 illustrates a method of transmitting to and receiving electromagnetic radiation from a target, comprising:
transmitting 800 and receiving 804 the electromagnetic radiation on a (e.g., complex wavefront) transceiver and/or a common transceiver aperture, wherein the electromagnetic radiation transmitted from the aperture interacts 802 with a target (e.g., is reflected from, transmitted through, or received on, the target) to form output electromagnetic radiation that is also received on the transceiver aperture (e.g., on the same photonic radiator as transmitted the electromagnetic radiation) for processing by the complex wavefront transceiver to determine a property of the target or a signal received from the target).

22. The method of embodiment 21, wherein the transceiver aperture comprises the transceiver aperture of any of the embodiments 1-17 or the transceiver of any of the embodiments 1-17.

23. A common aperture transceiver 400 comprising the aperture of any of the examples 1-22, comprising the beamformer 402, wave plate 404, and the aperture on one or more chips 450 (e.g., on a single chip).

24. The aperture 200 of any of the embodiments 1-23 on a single chip or comprising a photonic integrated circuit.

25. The aperture of any of the embodiments 1-24, wherein the optical mixer comprises an MMI or directional coupler comprising a first coupler input (Tx input), a second coupler input/output 212; a first coupler output 214, and a second coupler output 220 and optionally waveguides 280 (e.g., as illustrated in FIG. 2b).

26. A hybrid architecture comprising the transceiver 400 (e.g., FIG. 4 system and comprising the aperture of any of the embodiments 1-25) as Tx and Rx as in FIG. 1).

27. One or more transceivers of any of the embodiments 1-26 each comprising the aperture 200 as both the transmitter and the receiver apertures in FIG. 1(b)). In one embodiment, one transceiver 400 comprises a first dual polarization transceiver radiates in one polarization, and a second transceiver 400 comprises a second dual polarization transceiver radiates in the perpendicular polarization. In another embodiment, the transceiver 400 comprises a first dual polarization transceiver comprising a first one of the apertures 200, 406 radiating in one polarization, and a second transceiver comprises a second one of the apertures 200, 406 comprising a second dual polarization transceiver radiating in the perpendicular polarization The combined system can radiate both s and p polarizations and receiver collect and processes both s and p polarizations. The modified architecture can be used for polarimetry, polarization diverse transceiver, or to double the data transmission bandwidth in point-to-point communication systems.

28. On or more of the apertures 200 of any of the embodiments 1-27 each of the apertures comprising the transmitter and the receiver aperture. In one embodiment, one transceiver aperture 200, 406 comprises a first dual polarization transceiver aperture radiates in one polarization, and a second transceiver aperture 406, 200 comprises a second dual polarization transceiver radiates in the perpendicular polarization. The combined system can radiate both s and p polarizations and receiver collect and processes both s and p polarizations. The modified architecture can be used for polarimetry, polarization diverse transceiver, or to double the data transmission bandwidth in point-to-point communication systems.

29. A single chip comprising the transceiver or aperture of embodiments 27 or 28.

30. The transceiver of any of the embodiments 1-29 wherein the beamformer comprises a lens.

31. An integrated photonic architecture for photonic wave-front transmission and reception using a common aperture. This architecture enhances the performance of optical transceivers by utilizing the reliability and repeatability of integrated photonics platforms. This integration enables enhanced beam processing capabilities at a reduced size, cost, and complexity. This architecture can enhance coherent transceiver performance for many applications, including remote sensing, LiDAR, high-speed data communication, medical imaging, and high-performance computing. It can use Integrated photonics, silicon photonics, complex wave-front transceiver, common aperture transceiver.

### REFERENCES

The following references are incorporated by reference herein.
[1] Behrooz Abiri, Firooz Aflatouni, Angad Rekhi, and Ali Hajimiri. Electronic two-dimensional beam steering for integrated optical phased arrays. In Optical Fiber Communication Conference, page M2K.7. Optica Publishing Group, 2014. doi:10.1364/OFC.2014.M2K.7. URL https://opg.optica.org/abstract.cfm?URI-OFC-2014-M2K.7.
[2] Seyed Mohammadreza Fatemi, Aroutin Khachaturian, and Seyed Ali Hajimiri. Multi-beam optical phased array, Mar. 9 2021. U.S. Pat. No. 10,944,477.
[3] Aroutin Khachaturian, Reza Fatemi, and Ali Hajimiri. Achieving full grating-lobe-free field of view with low-complexity co-prime photonic beamforming transceivers. Photon. Res., 10(5): A66-A73, May 2022. doi: 10.1364/PRJ.437518. URL http://opg.optica.org/prj/abstract.cfm?URI=prj-10-5-A66.
[4] M. Ware and J. Peatross. Physics of Light and Optics (Black & White). Brigham Young University, Department of Physics, 2020. isbn:9781312929272. URL https://books.google.com/books?id=Cw2LDwAAQBAJ.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A transceiver aperture, comprising:
an array of pixels, each of the pixels comprising:
a photonic radiator comprising one or more ports;
a photonic mixer comprising an Rx input and a local oscillator (LO) input; and
an optical mixer comprising a Tx input; an input/output port; a first output; and a second output, wherein the input/output port is coupled to the one or more ports of the photonic radiator and the first output is coupled to the Rx input.

2. The transceiver aperture of claim 1, wherein the optical mixer comprises a multi-mode interferometer (MMI).

3. The transceiver of claim 1, wherein the photonic radiator comprises a directional coupler, a grating coupler, or a multi port radiator (MDR) comprising multiple ports for input/output of different polarizations of electromagnetic radiation received on or transmitted to the MDR.

4. The transceiver aperture of claim 1, wherein the photonic radiator comprises a multiport radiator comprising an array of square gratings.

5. The transceiver aperture of claim 1, wherein:
the photonic radiator comprises a multiport radiator comprising the ports comprising:
one or more Tx ports for input of a Tx signal for generating a first polarization of electromagnetic radiation transmitted from the photonic radiator; and
one or more Rx ports for output of an Rx signal in response to a second polarization of the electromagnetic radiation received on the photonic radiator;
the Tx ports and the Rx ports are each coupled to the input/output port of the optical mixer; and
the optical mixer routes the Tx ports to the Tx input and the Rx ports to the Rx input via the first output.

6. The transceiver aperture of claim 5, wherein:
the first polarization is different from the second polarization; and
the first polarization and the second polarization each independently comprise a linear polarization, a circular polarization, or elliptical polarization.

7. A transceiver comprising the aperture of claim 5, further comprising:
a beamformer; and
a quarter wave plate (or polarization beam splitter) optically coupled between the photonic radiator and the beamformer, wherein the electromagnetic radiation transmitted from or received on the photonic radiator is transmitted through the quarter wave plate (or the beamsplitter) to/from the beamformer.

8. The transceiver aperture of claim 5, wherein each of the pixels further comprises:
the Tx ports comprising a first Tx port; a second Tx port; and a third Tx port, the third Tx port connected to the photonic radiator via the first Tx port and the second Tx port;
a first splitter connecting the third Tx port to a first Tx waveguide and a second Tx waveguide,
a first phase shifter, the first Tx waveguide connecting the first phase shifter between the first splitter and the first Tx port;
the Rx ports comprising a first Rx port; a second Rx port; and a third Rx port, the third Rx port connected to the photonic radiator via the first Rx port and the second Rx port;
a second splitter connecting the third Rx port to a first Rx waveguide and a second Rx waveguide; and
a second phase shifter, the first Rx waveguide connecting the second phase shifter between first Rx port and the second splitter.

9. The transceiver aperture of claim 5, wherein each of the pixels comprise:
the Tx ports comprising a plurality of Tx ports; a Tx splitter configured to control a power of the electromagnetic radiation inputted to each of the Tx ports; and a Tx phase shifter coupled to control a relative phase of the Tx signal inputted to each of the ports so as to adjust a transmit polarization of the electromagnetic radiation transmitted from the photonic radiator in response to the Tx signals; and
the Rx ports comprising a plurality of Rx ports; an Rx splitter configured to control and combine a power of the Rx signals outputted from each of the Rx ports in response to electromagnetic radiation received on the photonic radiator; and an Rx phase shifter coupled to control a relative phase of the Rx signals outputted from each of the ports, so as to correctly receive a polarization of the electromagnetic radiation.

10. The transceiver aperture of claim 5, further comprising:
a Tx beamformer; comprising:
a 1:N power splitter having an input and N outputs, wherein N is a number of the pixels and each of the N outputs is connected to a different one of the photonic radiators in a different one of the pixels; and
a first plurality of N phase shifters, wherein the i^{th} one of the phase shifters couples the i^{th} one of the N outputs to the i^{th} one of the pixels, for 1≤i≤N; and
an Rx beamformer, comprising:
a 1:N power combiner having N inputs and one output, wherein each of the N inputs is connected to a different one of the photonic radiators in a different one of the pixels; and
a second plurality of N phase shifters, wherein the i^{th} one of the phase shifters couples the i^{th} one of the N inputs to the i^{th} one of the pixels, for 1≤i≤N.

11. A phased array transceiver comprising the aperture of claim 10.

12. The transceiver aperture of any of the claims 8-10, further comprising a computer coupled to the power splitter, the phase shifters, and the power combiner, wherein the computer is configured to:
control the phase shifters to control a relative phase of the Tx signals inputted to each of the Tx ports or the Rx signals received from each of the Rx ports; and
control the splitter to control the power of the Tx signals transmitted to each of the Tx ports; and
control the combiner to control a power of the Rx signals outputted from each or the Rx ports.

13. The transceiver aperture of claim 1, wherein the photonic mixer comprises a detector positioned to detect the Rx signal received at the Rx input and a LO signal received at the LO input and output a signal in response thereto, the signal comprising a difference frequency between a frequency of the LO signal and a frequency of the Rx signal.

14. The transceiver of claim 13, wherein the photonic mixer comprises an In phase-Quadrature (IQ) mixer.

15. A complex wavefront transceiver comprising the aperture of claim 1, wherein the photonic radiator transmits and receives an arbitrary complex wavefront through the aperture, wherein the wavefront comprises any arbitrary superposition of sine waves having different phases and/or amplitudes.

16. A LIDAR, a high-speed data communication system, a medical imaging system, a high-performance computing system, or a remote sensing system comprising the complex wavefront transceiver of claim 15.

17. The transceiver aperture of claim 9, wherein the relative phase and power are selected to convert the Tx signal or Rx signal associated with linear polarization to circular or elliptical polarization.

18. The transceiver aperture of claim 9 or 5, wherein at least one of the Rx signal, the Tx signal, a relative phase of the Rx or Tx signal, or a power of the Rx/Tx signals are selected to generate the electromagnetic radiation having any arbitrary combination of s polarization and p polarization.

19. A method of making a transceiver aperture, comprising:
lithographically forming an array of pixels on a silicon on insulator substrate, each of the pixels comprising a photonic integrated circuit comprising:
a photonic radiator comprising one or more ports;
a photonic mixer comprising an Rx input and a local oscillator (LO) input; and
an optical mixer comprising a Tx input; an input/output port; a first output; and a second output, wherein the input/output port is coupled to the one or more ports of the photonic radiator and the first output is coupled to the Rx input.

20. The method of claim 18, further comprising forming waveguides connecting the photonic radiator, the photonic mixer; and the optical mixer.
